(19) United States
(12) Patent Application Publication
(10) Pub. No.: US 2007/0027562 A1
(43) Pub. Date: Feb. 1, 2007

(54) System and method for facilitating competition based on disparate measures of performance

(76) Inventor: Adam Stephen de Voghelaere Parr, London (GB)

Correspondence Address: WOLF, BLOCK, SHORR AND SOLIS-COHEN LLP, 250 PARK AVENUE, 10TH FLOOR, NEW YORK, NY, 10177, US

(21) Appl. No.: 11/482,442

(22) Filed: Jul. 7, 2006

(30) Foreign Application Priority Data
Jul. 7, 2005 (AU) 2005 903612

(51) Int. Cl. G06F 19/00

(52) U.S. Cl. 700/91

(57) ABSTRACT

A method for improving performance in a business organisation by facilitating competition between two or more different participants within the business, the method comprising; (a) one or more servers, and (b) one or more remote terminals accessible by the participants, wherein the method includes the steps of; (1) choosing a measure of participant performance, (2) inputting the measure of participant performance to a remote terminal, (3) calculating a score based on the measure of performance, the calculation being performed at the server, or performed at the remote terminal for communication to the server; (4) collating and ranking the scores, and (5) displaying the relative scores of the participants.

### TECHNICAL FIELD OF THE INVENTION

This invention relates to business management systems and, more specifically, to a system and method for evaluating disparate measures of performance so as to allow participants engaged in different business activities to compete against one another.

### BACKGROUND OF THE INVENTION

In this specification where a document, act or item of knowledge is referred to or discussed, this reference or discussion is not an admission that the document, act or item of knowledge or any combination thereof was at the priority date publicly available, known to the public, part of the common general knowledge or known to be relevant to an attempt to solve any problem with which this specification is concerned.

Competition has long been recognised as an effective way to improve performance within a group, and any competition requires a means by which the relative position of participants may be determined. This is generally a simple undertaking when the participants are engaged in the same activity, and are therefore subject to the same measures of performance. The appropriate measures of performance will depend on the nature of the activity. For example, in a business environment such measures could include profitability, sales volume, production output, or the number of hours lost due to accidents. For large businesses with numerous functional divisions that perform a range of activities, assessment of the relative performance of units within a particular division is relatively simple, as their performance can be directly compared using the same criteria. However, for managers charged with improving performance across an entire organisation it is desirable to foster some degree of competition between different functional divisions. This is made difficult by the disparate measures used to gauge the performance of divisions engaged in different activities. For example, competition between different sales teams could be based on a shared measure of performance such as sales volume, and would be relatively simple to establish, but competition between a sales team and a maintenance crew becomes more difficult.

The present invention provides a new and improved method for evaluating disparate measures of performance so as to allow participants engaged in different business activities to compete against one another. In addition to providing an incentive to improve performance, this fosters teamwork within individual units while reminding them that they are part of a larger organisation working towards a common goal.

### SUMMARY OF THE INVENTION

In accordance with one embodiment of the invention, a system and method are disclosed for improving performance in a business organisation by facilitating competition between participants within the business, such as different business groups, irrespective of the disparate measures by which the performance of those groups may be measured.

Typically the present invention provides a method for improving performance in a business organisation by facilitating competition between two or more different participants within the business, the method comprising;

(a) one or more servers, and

(b) one or more remote terminals accessible by the participants, wherein the method includes the steps of;

(1) choosing a measure of participant performance,

(2) inputting the measure of participant performance to a remote terminal,

(3) calculating a score based on the measure of performance, the calculation being performed at the server, or performed at the remote terminal for communication to the server;

(4) collating and ranking the scores, and

(5) displaying the relative scores of the participants.

Steps 2 to 5 may be carried out once, or repeated multiple times until the competition is terminated until a terminating event occurs, such as for example, by one or more participants reaching a predetermined score.

Typically the present invention provides a system for improving performance in a business organisation by facilitating competition between two or more different participants within the business, the system comprising;

(a) one or more servers, and

(b) one or more remote terminals accessible by the participants, wherein the system includes;

(1) communicating a measure of participant performance to a remote terminal,

(2a) communicating the measure of participant performance to the server for calculation of a score, or

(2b) communication to the server a score calculated at the remote terminal,

(3) communication of collated and ranked scores to the remote terminal, and

(4) display of the collated and ranked scores to show their relative values.

Participants in the competition each elect, or have selected for them, one or more measures of performance that are capable of regular determination and are applicable to their day-to-day business activities. Ideally, the measures chosen should be those for which a target or benchmark (for example, a budget) is set on a periodic basis.

The chosen measures may be characterised by type. Depending on what is being measured, a smaller or a larger value may be preferable. Similarly, some measures may fall on a finite scale, such as those expressed as percentage values (0-100%), whereas others may be open-ended; some may be positive, others may be negative.

Typically data for each of the chosen measures is entered into the system on a regular basis, and certain calculations are performed on that data to determine a score for each participant. The precise calculations performed will depend on the type of measure, but each case involves comparing each participant's performance to its past performance and to its predetermined targets or benchmarks for each measure.

In effect, typically the scores produced are a measure of each participant's performance against itself, which provide a common measure shared by all participants irrespective of differences in the underlying measures used to generate those scores. Direct competition between participants based on this shared measure then becomes possible.

In a system according to one embodiment of the invention, a server is configured to receive and store the data entered in respect of each participant, to perform the relevant calculations, and to generate a representation showing the relative position of the participants in the competition based on their calculated scores. Participants may access that server either directly or via a network for the purpose of entering data and viewing the results of the competition. Those results may be represented in a number of forms, either numerically or graphically.

Typically, the participants are individuals, teams or business units within a company, or a company itself within a broader corporate group. Participants may compete individually and/or as part of larger teams. For example, if a number of business units from two different companies within a corporate group participated as separate entities, then competition could occur between individual participants, and between the broader ‘teams’ to which those participants belong, such as the two companies for which they work.

At least one measure of performance may then be selected for each participant to serve as the basis on which their performance in the competition will be assessed. The selected measure(s) should be capable of regular determination and should be relevant to the business activities of the participant. The measures chosen are typically those for which a target or benchmark (for example, a budget) is set, or can be set, on a periodic basis. Budgeted performance targets for each fiscal year, and the measures for which these targets are set could be suitable performance measures for use in the present invention. The selection of appropriate measures may be left to the discretion of the participants, or be subject to selection or review by a third party such as a manager or an administrator of the competition

The chosen measures are typically characterised by type. Depending on what is being measured, a smaller or a larger value may be preferable. Similarly, some measures may fall on a finite scale, such as those expressed as percentage values (0-100%), whereas others may be open-ended.

Data for each of the chosen measures can be entered into the system on a regular basis. That data may be entered by the participants, by a third party, or even fed automatically into the system by another computer system. The data may be entered, stored and processed on the client computer, or entered on the client computers then transmitted to the server for storage and processing.

Calculations can be performed on the data entered to determine a score for each participant for each performance measure, and a combined overall score for each participant if they have selected more than one performance measure. These calculations may be performed either by the client computers or by the server. If the calculations are performed on the client computers, then the results are transmitted to the server for storage, further processing and display as outlined below. If the calculations are performed on the server, then the results can be stored on the server for further processing. The precise calculations performed on the data will depend on the type of performance measure in question.

The calculations to be performed on the data to determine the participant's score depend on the nature of the measure to which that data relates. For example, some measures may be expressed as units, and others may be expressed as percentages, some may fall on a finite scale, whereas others may be open-ended. For example, the measure of participant performance may be based on a value chosen from the group comprising sales values, budget values, production values, wastage values or occupational health and safety values. In some cases (such as production or sales), a higher value may be better, while in others (such as wastage or accidents) a lower value may be preferable. The first step in the calculation process is typically a determination of the type of measure involved, which allows the appropriate calculations to be used.

In one embodiment of the present invention, the various types of measures are grouped into four categories—unit positive (measured in units, where higher values represent better results), unit negative (measured in units, where lower values represent better results), percentage positive (measured as a percentage, where higher values represent better results), and percentage negative (measured as a percentage, where lower values represent better results).

In each case, a series of general calculations are performed on the data entered for each measure. The broad purpose of these calculations is to assess and assign a numerical score to each participant's change in performance and/or their performance against predetermined targets.

In one embodiment the participant's change in performance may be calculated by comparing, for each measure:

the average for the current calculation period (eg. the past week) to the average for the previous calculation period (eg. the previous week);

the average for the current calculation period to the average for the year to date; and

the variance in values for the current calculation period to the variance for the previous calculation period.

The participant's performance against a predetermined target may be calculated by comparing, for each measure:

the average for the year to date to the target for that year; and

the average for the current calculation period to the target for that year.

Each of these factors may be weighted according to their relative importance when determining the overall score for the measure in question.

The overall scores for each participant can then be collated and ranked by the server and the individual scores and relative positions of the participants displayed. Consistent with the present invention, these results may be displayed in numerous ways. For example, the results may simply be displayed in numerical form, as a list or table, or may be represented graphically by depicting each participant as a separate car in a race and using the numerical scores to determine the relative position of those cars on a race track.

The competition described by the present invention may comprise one round or a number of rounds. Data may be entered and scores determined and displayed at discrete intervals, or continuously, with data entry, score calculation and display occurring constantly on a ‘real time’ basis while the competition continues. When the competition comes to an end the final scores and relative positions of the participants are determined. In one embodiment, when the competition comprises a number of discrete rounds, then the participants may be allocated a certain number of points for their relative position at the end of each round. Those points may be collated at the end of the competition to determine the overall winners. Points may be earned by individual participants, and by any larger teams into which those participants may be aggregated.

The present invention is typically fully automated. The server used for carrying out the method of the present invention may be configured to:

(i) receive and store the measure of participant performance from a remote terminal,

(ii) calculate a score based on the measure of participant performance or receive and store a score calculated at a remote terminal,

(iii) collate and rank the calculated score, and

(iv) display the relative scores of the participants.

The operation of the server and remote terminal is typically controlled by a code including:

(1) programming code for receiving input of a measure of participant performance to a remote terminal,

(2a) programming code for calculating a score based on the measure of performance at the server, or

(2b) programming code for calculating a score based on the measure of performance performed and programming code for communicating the score to the server,

(3) programming code for collating and ranking the scores, and

(4) programming code for displaying the relative scores of the participants.

The invention may further include code for calculating a participant's change in performance. Specifically the invention may include;

programming code for calculating a first average score for a first calculation period and comparing the first average score with a second average score for a second calculation period,

programming code for calculating a first average score for a first calculation period and comparing the first average score with a second average score for a calculation period comprising the year to date,

programming code for calculating a first variance in scores for a first calculation period and comparing the first variance in scores with a second variance in scores for a second calculation period.

### BRIEF DESCRIPTION OF THE DRAWINGS

The present invention will now be further described with reference to the drawings in which:

FIG. 1 illustrates a computer system that may be used to implement the present invention.

FIG. 2 is a flow diagram illustrating the basic sequence of steps in a competition consistent with one embodiment of the present invention.

FIG. 3 is a flow diagram illustrating the calculations performed on data entered by each participant in one embodiment of the present invention.

FIG. 4 is a table containing an exemplary set of data and calculation results stored by one embodiment of the present invention for a participant using one measure of performance.

FIG. 5 is a table containing an exemplary set of data and calculation results stored by one embodiment of the present invention for a participant using two different measures of performance.

FIG. 6 is a table containing an exemplary set of data and calculation results stored by one embodiment of the present invention for a participant using three different measures of performance.

FIG. 7 illustrates one embodiment of a method for displaying the results from the calculation examples illustrated in FIGS. 4 to 6.

### DETAILED DESCRIPTION OF THE INVENTION

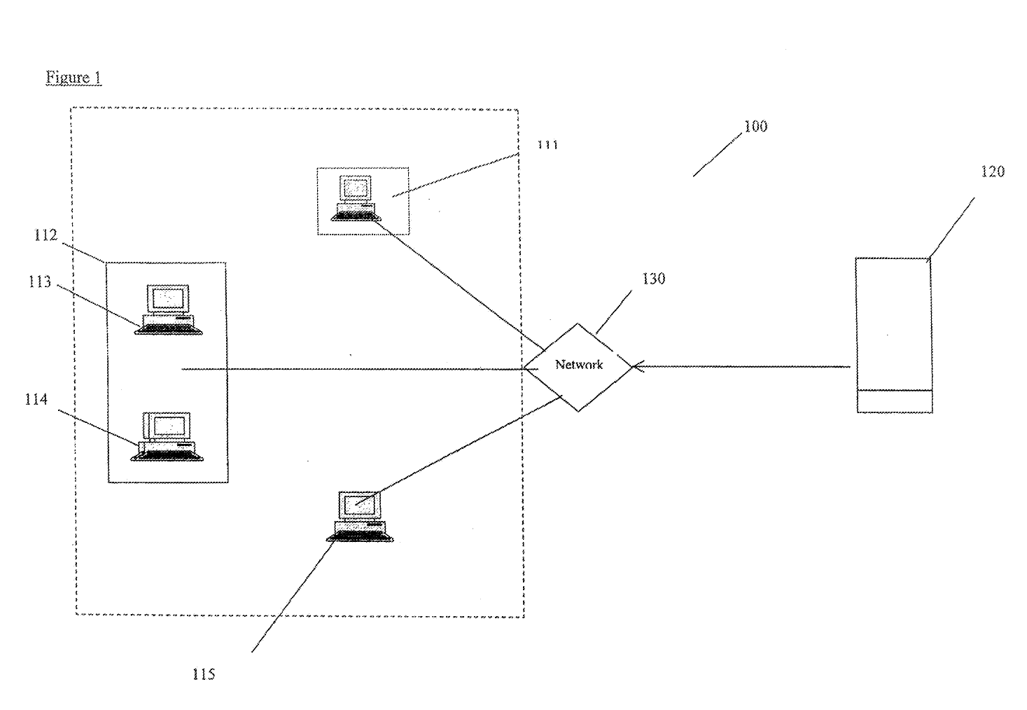

FIG. 1 is a diagram illustrating one embodiment of a system 100 according to the current invention. System 100 includes, but is not limited to, one or more client computers 110 connected to one or more servers 120 by a network 130. Clients 110 participate in a competition hosted by a server 120, and may submit data to and receive results from that server 120 via a network 130. Clients 110 and server 120 may be located anywhere in the world. For example, clients 110 may all be located in the same building as server 120, and network 130 may be a local area network, or clients 111 and 115 may be located at remote mine sites on different continents and connected to server 120 via the internet, to which access may be facilitated by satellite, whereas clients 112 and 113 may be located in the same building and connected via a local area network 114 to the internet, and thereby to server 120.

Clients 110 are generally operated by different elements of the one business organisation, for example, by different companies within a corporate group, or by different operating divisions within one of those companies. Server 120 may be operated by the same business organisation, or by an external service provider. To continue the previous example, client 111 may be operated by the department responsible for production at a mine in Australia, client 115 may be operated by the department responsible for maintenance at a mine in South America, client 112 may be operated by the IT department of the company's head office in the USA, and client 113 may be operated by the sales and marketing department, also in the USA head office.

Server 120 includes, among other things, a suitable device for storing data, and a processor for manipulating that data. In one embodiment of the present invention, clients 110 transmit data to server 120 via the network 130, and that data is stored on the server 120. Also stored on the server 120 are certain instructions regarding the processing of the stored data in accordance with the present invention. In another embodiment of the present invention, the data may be processed on the client computers 110, and the results transmitted to the server 120 for collation and storage.

The processing of the stored data in accordance with the instructions may occur either as it is received, on a scheduled basis, or upon receipt of a request for results.

Upon receipt of a request for results, the server 120 may either perform the necessary calculations on the stored data in accordance with the instructions or retrieve the results of previously performed calculations, and transmit those results to the requesting client 110. The results will generally be embodied in an internet page, which may be either a pre-generated static page or a page that is dynamically generated by the server in response to the client's request, and are transmitted to the relevant client via a network 130 using hypertext transfer protocol (HTTP) or a similar data transfer protocol. In one embodiment of the present invention, the network 130 is a secure network such as a company intranet, and access to the results from the server 120 is restricted to those clients 110 with access to that secure network.

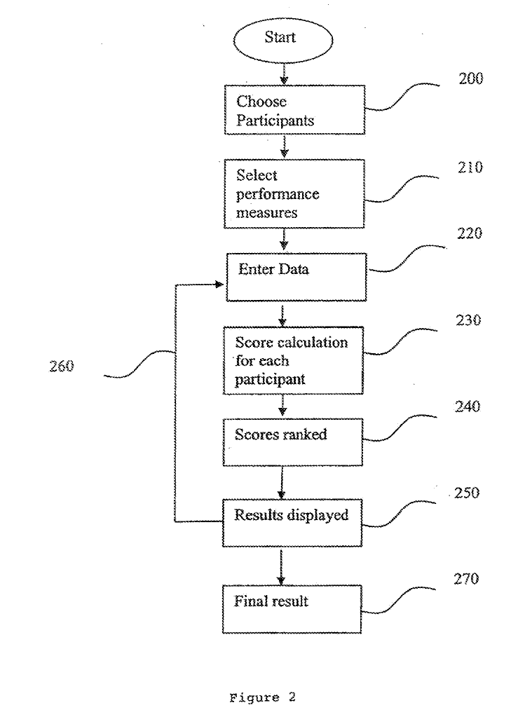

FIG. 2 is a flow diagram illustrating the basic sequence of steps in a competition consistent with one embodiment of the present invention.

In step 200, the competition begins with the selection of the participants. In one embodiment, the participants may be individuals, teams or business units within a company, or a company itself within a broader corporate group. Participants may compete individually and/or as part of larger teams. For example, if a number of business units from two different companies within a corporate group participated as separate entities, then competition could occur between individual participants, and between the broader ‘teams’ to which those participants belong, such as the two companies for which they work.

In step 210, at least one measure of performance is selected for each participant to serve as the basis on which their performance in the competition will be assessed. The selected measure(s) should be capable of regular determination and should be relevant to the business activities of the participant. In one embodiment, the measures chosen should also be those for which a target or benchmark (for example, a budget) is set, or can be set, on a periodic basis. In many businesses, budgeted performance targets are set for each fiscal year, and the measures for which these targets are set would be suitable performance measures for use in the present invention. The selection of appropriate measures may be left to the discretion of the participants, or be subject to selection or review by a third party such as a manager or an administrator of the competition.

The chosen measures are characterised by type. Depending on what is being measured, a smaller or a larger value may be preferable. Similarly, some measures may fall on a finite scale, such as those expressed as percentage values (0-100%), whereas others may be open-ended.

In step 220, data for each of the chosen measures is entered into the system described in FIG. 1 on a regular basis. That data may be entered by the participants, by a third party, or even fed automatically into the system by another computer system. As described with regard to FIG. 1, the data may be entered, stored and processed on the client computers 110, or entered on the client computers 110 then transmitted to the server 120 for storage and processing.

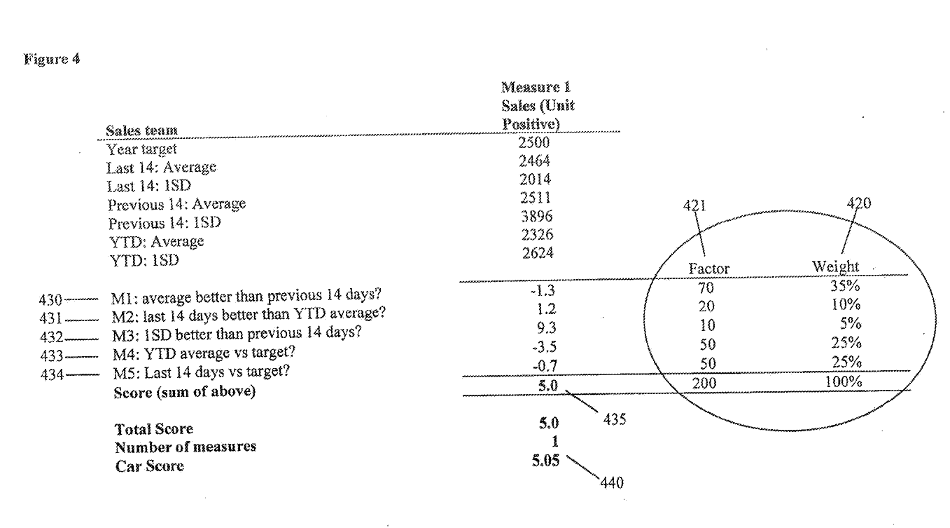

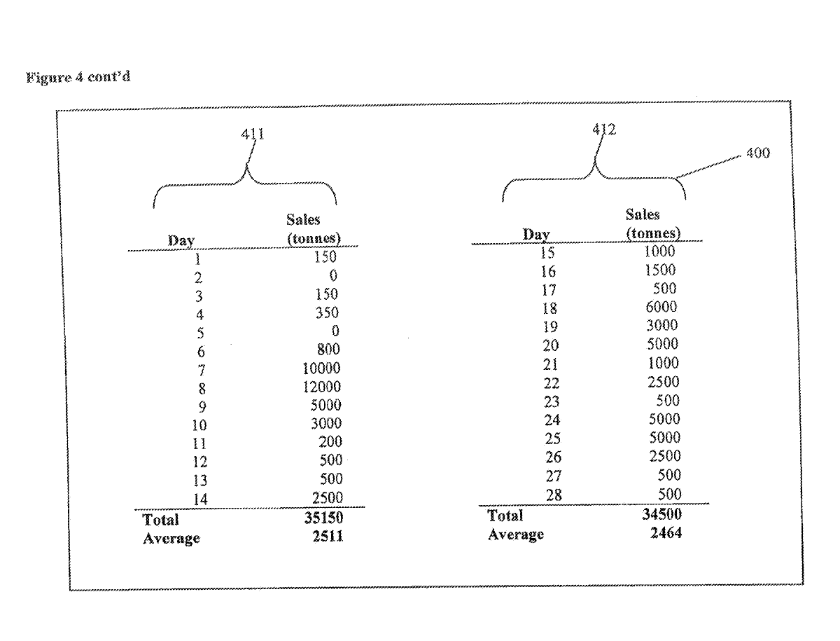

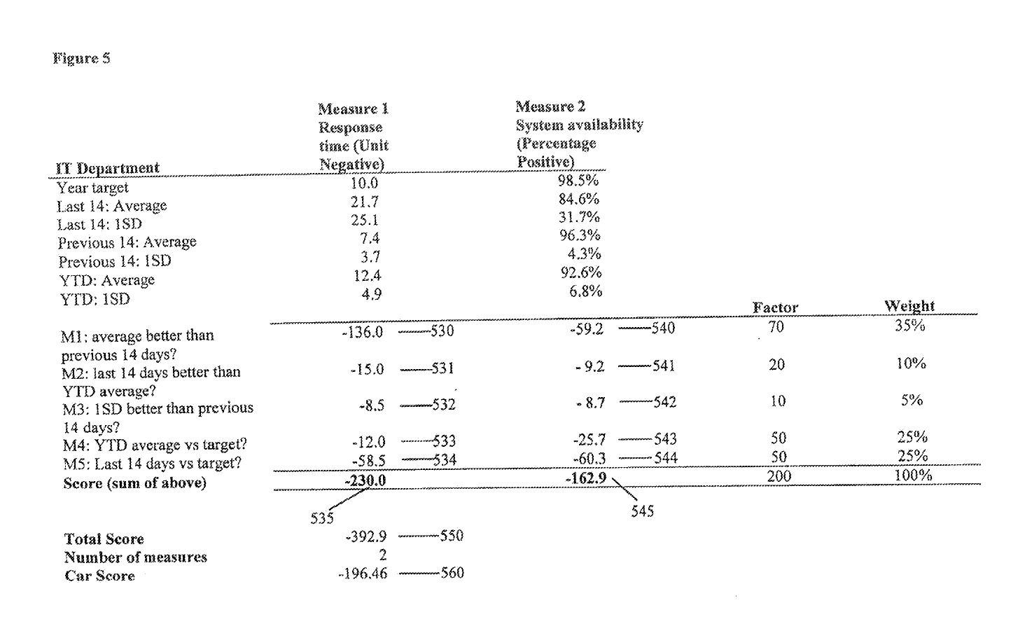

In step 230, calculations are performed on the data entered in step 220 to determine a score for each participant for each performance measure, and a combined overall score for each participant if they have selected more than one performance measure. These calculations may be performed either by the client computers 110 or by the server 120. If the calculations are performed on the client computers 110, then the results are transmitted to the server 120 for storage, further processing and display as outlined below. If the calculations are performed on the server 120, then the results are stored on the server for further processing and display as outlined below. The precise calculations performed on the data will depend on the type of performance measure in question, and are described in more detail in connection with FIG. 4 below.

In step 240, the overall scores for each participant are collated and ranked by the server 120 and, in step 250, the individual scores and relative positions of the participants are displayed. Consistent with the present invention, these results may be displayed in numerous ways. For example, the results may simply be displayed in numerical form, as a list or table, or may be represented graphically by depicting each participant as a separate car in a race and using the numerical scores to determine the relative position of those cars on a race track.

The competition described by the present invention may comprise a number of rounds, with data being entered and scores being determined and displayed in accordance with steps 220, 230, 240 and 250 at discrete intervals, or may be a continuous process with data entry, score calculation and display occurring constantly on a ‘real time’ basis. While the competition continues, then following each display of results 250 the process will loop back 260 to the entry of further data in accordance with step 220. That loop 260 is broken when the competition comes to an end 270, at which point the final scores and relative positions of the participants are determined. In one embodiment, when the competition comprises a number of discrete rounds, then the participants may be allocated a certain number of points for their relative position at the end of each round. Those points may be collated at the end of the competition to determine the overall winners. Points may be earned by individual participants, and by any larger teams into which those participants may be aggregated.

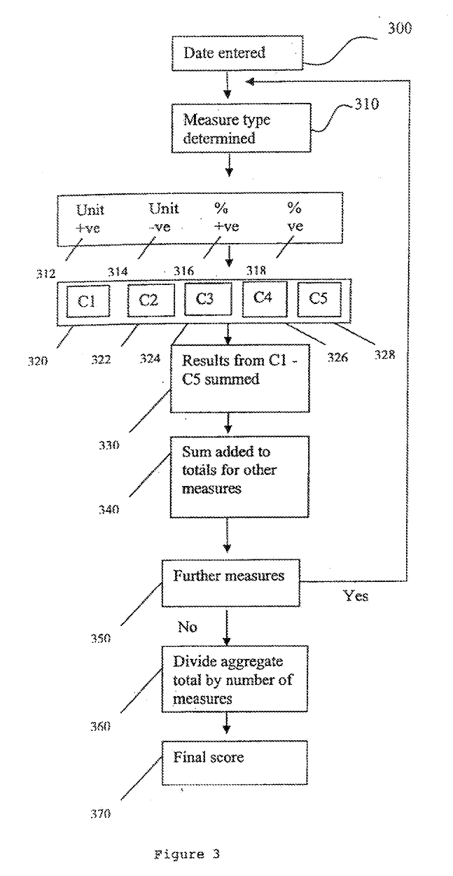

FIG. 3 is a flow diagram illustrating the general calculations performed on the data entered by each participant in one embodiment of the present invention.

As described in relation to step 210 above, each participant in the competition in the competition elects the measures against which their performance is to be judged. Any number of measures may be used, with each participant's overall score being the average of their scores for each measure.

Once the measures are selected, data in respect of each measure is entered 300 into the system by or on behalf of the participants.

The calculations to be performed on the data to determine the participant's score depend on the nature of the measure to which that data relates. For example, some measures may be expressed as units, and others may be expressed as percentages, some may fall on a finite scale, whereas others may be open-ended. In some cases (such as production or sales), a higher value may be better, while in others (such as wastage or accidents) a lower value may be preferable. The first step 310 in the calculation process is therefore to determine the type of measure involved, which allows the appropriate calculations to be used.

In one embodiment of the present invention, the various types of measures are grouped into four categories—unit positive 312 (measured in units, where higher values represent better results), unit negative 314 (measured in units, where lower values represent better results), percentage positive 316 (measured as a percentage, where higher values represent better results), and percentage negative 318 (measured as a percentage, where lower values represent better results).

In each case, a series of general calculations are performed on the data entered for each measure. The broad purpose of these calculations is to assess and assign a numerical score to each participant's change in performance and their performance against predetermined targets.

In one embodiment the participant's change in performance may be calculated by comparing, for each measure:

the average for the current calculation period (eg. the past week) to the average for the previous calculation period (eg. the previous week);

the average for the current calculation period to the average for the year to date; and

the variance in values for the current calculation period to the variance for the previous calculation period.

The participant's performance against a predetermined target may be calculated by comparing, for each measure:

the average for the year to date to the target for that year; and

the average for the current calculation period to the target for that year.

Each of these factors may be weighted according to their relative importance when determining the overall score for the measure in question. In the example illustrated in FIG. 3, the short term trend for each measure is calculated 320 by comparing the average value for the current calculation period to the average value for the previous calculation period, and is given a weighting of 35% of the overall score. The long term trend is calculated 322 by comparing the average for the current calculation period to the average for the year to date, and is weighted at 10%. Changes in the consistency of each participant's performance are assessed 324 by comparing the standard deviation of the values for the current calculation period to the standard deviation of the values for the previous calculation period and, in this example, is weighted at 5%. Performance against predetermined targets is calculated by comparing 326 the year-to-date average to the target average for that year, and by comparing 328 the average for the current calculation period to the target average for that year, with the results each being weighted at 25% of the overall score for that measure. In the example illustrated in FIG. 3, half of each participant's score is therefore based on performance trends (ie. whether it is improving, stable, or deteriorating) and half is based on performance against their target for that year. However, this is but one example, and the weightings may be altered to reflect the different priorities of different enterprises.

The above calculations are repeated 350 for each measure selected, and the results are added together 340 to produce an aggregate score for each participant. The aggregate score for each participant is then divided 360 by the number of measures used by that participant, to produce an average. That average then constitutes the participant's final score 370 for that round of calculations.

FIGS. 4 to 6 illustrate three teams participating in one embodiment of the invention, using a variety of performance measures. In the particular embodiment illustrated in these examples, data is entered by participants and calculations are made on a fortnightly basis. For the purpose of these examples, data has therefore been provided for 28 days, or two consecutive calculation periods.

FIG. 4 is a table containing an exemplary set of data and calculation results stored by one embodiment of the present invention for a participant using a single measure of performance. In this example, the participant is a sales team, and the selected measure of performance is sales volume in tonnes. This is regarded as a ‘unit positive’ measure, as it is expressed in units, and the higher the unit value the better the result. Data 400 for the selected measure has been entered for two consecutive fortnights. In this embodiment, five calculations are performed on the data 400 to produce the participant's weighted score 440. The relative contribution made by each of the five calculations towards the final score 440 will vary according to the priorities of the organisation implementing the invention, but in this case the weights attached to each calculation are set out in column 420 as percentage values. In this case, short term improvement is the most important factor, contributing 35% towards the final score. For ease of calculation, these percentage values are converted into a numerical ‘factor’ 421, although the invention may be worked effectively without this step, as long as the figures used have the same relative value that corresponds with the desired weighting, and are applied consistently to each participant.

When comparing value X to value Y for unit positive measures, the general formula used is:

$$Δ = ( \frac{X}{Y} \times Z ) - Z$$

where Z is the relevant weighted factor and A is the weighted difference between X and Y.

In the first calculation 430, the short-term performance trend is determined by dividing the average for the most recent calculation period (in this case, the past 14 days) by the average for the preceding calculation period, multiplying the result by the relevant weighted factor 421, then subtracting the weighted factor from that result. In this case, the average for the most recent 14 days' performance data 412 is 2464 tonnes, and the average for the preceding 14 days' performance data 411 was 2511 tonnes. The result of the calculation is −1.3, with the negative value representing the fact that the average performance for this measure has deteriorated.

In the second calculation 431, the longer term performance trend is determined by dividing the average for the most recent calculation period by the average for the year to date, multiplying the result by the relevant weighted factor, then subtracting the weighted factor from that result. In this case, the average for the most recent 14 days' performance data 412 is 2464 tonnes, and the average for the year to date is 2326 tonnes. The result of the calculation is 1.2, with the positive value representing the fact that the average performance for this measure has improved.

In the third calculation 432, the short-term trend in variability of the performance results is determined by dividing the standard deviation of the performance figures the most recent calculation period by the standard deviation of the performance figures for the preceding calculation period multiplying the result by the relevant weighted factor, then subtracting the weighted factor from that result. In this case, the standard deviation for the most recent 14 days' performance data 412 is 2014, and the standard deviation for the preceding period's data was 3896. The result of the calculation is 9.3, with the positive value representing the fact that the variability in results has decreased, implying greater consistency of performance. Standard deviation is a well-known statistical algorithm, and is effectively a measurement of the average deviation from the mean within which the majority of results lie. A higher value indicates a greater ‘spread’ of results, and therefore greater variability.

In the fourth and fifth calculations, 433 and 434 respectively, the participant's performance against predetermined targets is assessed for each measure.

In calculation 433, the average for the year to date is divided by the target value for that year. The result of this is then multiplied by the relevant weighted factor, and the weighted factor is then subtracted from the result. In this case, the average for the year to date is 2326 tonnes, and the target value for the year is 2500 tonnes. The result of the calculation is −3.5, with the negative value reflecting the fact that the current average is below the target value.

In calculation 434, the average for the most recent calculation period is divided by the target value for that year. The result of this is then multiplied by the relevant weighted factor, and the weighted factor is then subtracted from the result. In this case, the average for the most recent calculation period is 2464 tonnes, and the target value for the year is 2500 tonnes. The result of the calculation is −0.7, with the negative value reflecting the fact that the current average is below the target value by a small amount.

The sum of the five weighted calculation results described above is 5.0, which gives the overall score for that measure. As there is only one measure in this case, this value is the participant's overall score 440 for this calculation round.

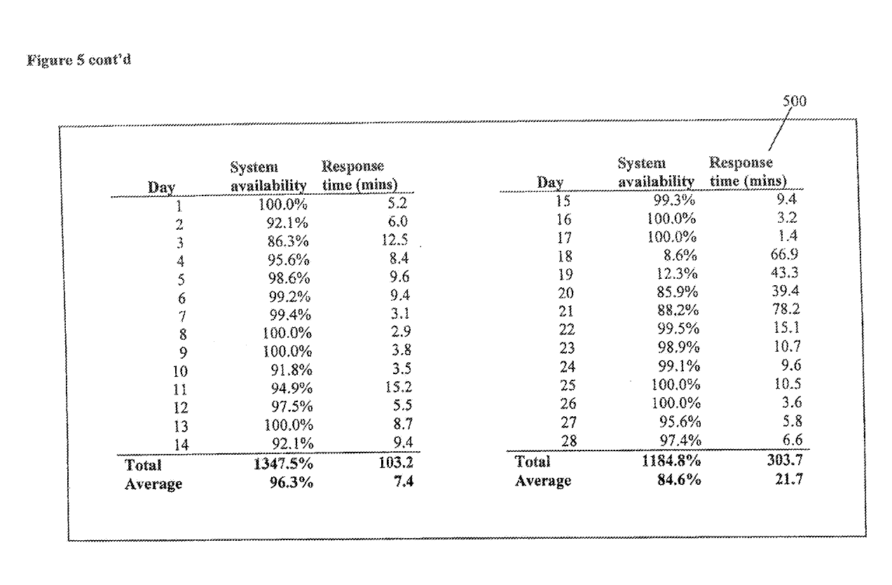

FIG. 5 is a table containing an exemplary set of data and calculation results stored by one embodiment of the present invention for a participant using two different measures of performance. In this example the participant is an information technology department, and the selected measures of performance are system availability (expressed as a percentage) and average response time to requests for assistance (expressed in minutes). In this case, system availability is a percentage positive measure (ie. a higher percentage is better), and response time is a unit negative measure (ie. a lower unit value is better).

The calculations for unit negative measures are the same as those for unit positive measures, although the results are multiplied by minus one (−1) to reflect the fact that the preferred trend is in the opposite direction. The exception to this is for the variance calculations, as a smaller variance is preferable irrespective of the preferred trend in the underlying measure.

When comparing value X to value Y for unit negative measures, the general formula used is therefore:

$$Δ = - [ ( \frac{X}{Y} \times Z ) - Z ]$$

where Z is the relevant weighted factor and A is the weighted difference between X and Y.

In the first calculation 530 for the unit negative measure (response time), the short-term performance trend is determined by dividing the average for the most recent calculation period (in this case, the past 14 days) by the average for the preceding calculation period, multiplying the result by the relevant weighted factor 531, then subtracting the weighted factor from that result. The end result is then multiplied by minus one. In this case, the average for the most recent 14 days' performance data is 21.7 minutes, and the average for the preceding 14 days' performance data was 7.4 tonnes. The result of the calculation is −136.0, with the strongly negative value representing the marked deterioration in performance on this measure.

In the second calculation 531 for the unit negative measure (response time), the longer term performance trend is determined by dividing the average for the most recent calculation period by the average for the year to date, multiplying the result by the relevant weighted factor, then subtracting the weighted factor from that result. The end result is then multiplied by minus one. In this case, the average for the most recent 14 days' performance data is 21.7 minutes, and the average for the year to date is 12.4 minutes. The result of the calculation is −15.0, with the negative value representing the fact that the average performance for this measure has deteriorated.

In the third calculation 532 for the unit negative measure (response time), the short-term trend in variability of the performance results is determined by dividing the standard deviation of the performance figures the most recent calculation period by the standard deviation of the performance figures for the preceding calculation period. multiplying the result by the relevant weighted factor, then subtracting the weighted factor from that result. In this case, the standard deviation for the most recent 14 days' performance data is 25.1, and the standard deviation for the preceding period's data was 3.7. The result of the calculation is −8.5, with the negative value representing the fact that the variability in results has increased, implying less consistency of performance.

In the fourth and fifth calculations, 533 and 534 respectively, the participant's performance against predetermined targets is assessed for each measure.

In calculation 533 for the unit negative measure (response time), the average for the year to date is divided by the target value for that year. The result of this is then multiplied by the relevant weighted factor, and the weighted factor is then subtracted from the result. The end result is then multiplied by minus one. In this case, the average for the year to date is 12.4 minutes, and the target value for the year is 10.0 minutes. The result of the calculation is −12.0, with the negative value reflecting the fact that the current average is higher than the target value.

In calculation 534 for the unit negative measure (response time), the average for the most recent calculation period is divided by the target value for that year. The result of this is then multiplied by the relevant weighted factor, and the weighted factor is then subtracted from the result. The end result is then multiplied by minus one. In this case, the average for the most recent calculation period is 21.7 minutes, and the target value for the year is 10.0 minutes. The result of the calculation is −58.5, with the strongly negative value reflecting the fact that the current average is more than double the target value.

In the case of values measured as a percentage, each value is processed by the system as a value between 0 and 1, ie. 50% would be 0.5, and 100% would be 1.0. This gives rise to a risk of division by zero, which generates a calculation error. As such, in this embodiment, each percentage value is first subtracted from 1.1, so a percentage of 0 would become 1.1, and 100% would become 0.1. When comparing value X to value Y for percentage positive measures, the general formula used is therefore:

$$Δ = ( \frac{1.1 - X}{ 1.1 - Y} \times Z ) - Z$$

where Z is the relevant weighted factor and Δ is the weighted % difference between X and Y. Values other than 1.1 may be used in other embodiments provided that the chosen value is used consistently across all participants—the key element is the ratio between values X and Y and the avoidance of division by zero.

In the first calculation 540 for the percentage positive measure (availability), the short-term performance trend is determined using the above formula, where X is the average for the most recent calculation period (in this case, the past 14 days), and Y is the average for the preceding calculation period. In this case, the average for the most recent 14 days' performance data is 84.6%, and the average for the preceding 14 days' performance data was 96.3%. The result of the calculation is −59.2, with the negative value representing the fact that the average performance for this measure has deteriorated.

In the second calculation 541 for the percentage positive measure (availability), the longer term performance trend is determined using the above formula, where X is the average for the most recent calculation period and Y is the average for the year to date. In this case, the average for the most recent 14 days' performance data is 84.6%, and the average for the year to date is 92.6%. The result of the calculation is −9.2, with the negative value representing the fact that the average performance for this measure has deteriorated.

In the third calculation 542 for the percentage positive measure (availability), the short-term trend in variability of the performance results is determined by dividing the standard deviation of the performance figures for the most recent calculation period by the standard deviation of the performance figures for the preceding calculation period, multiplying the result by the relevant weighted factor, then subtracting the weighted factor from that result. In this case, the standard deviation for the most recent 14 days' performance data is 31.7%, and the standard deviation for the preceding period's data was 4.3%. The result of the calculation is −8.7, with the negative value representing the fact that the variability in results has increased, implying less consistency of performance. Despite the large deterioration in consistency, a relatively low negative score is produced due to the low weighting (5%) for this calculation.

In the fourth and fifth calculations, 543 and 544 respectively, the participant's performance against predetermined targets is assessed for each measure.

In calculation 543 for the percentage positive measure (availability), the above formula is used, where X is the average for the year to date and Y is the target value for that year. In this case, the average for the year to date is 92.6%, and the target value for the year is 98.5%. The result of the calculation is −25.7, with the negative value reflecting the fact that the current average is below the target value.

In calculation 544 for the for the percentage positive measure (availability), the above formula is used, where X is the average for the most recent calculation period and Y is the target value for that year. In this case, the average for the most recent calculation period is 84.6%, and the target value for the year is 98.5%. The result of the calculation is −60.3, with the negative value reflecting the fact that the current average is well below the target value.

The scores for each of the participant's measures, 535 and 545, are then added together to produce the participant's aggregate score 550 for that calculation round. This is then divided by the number of measures used to produce that aggregate score (in this case, two) to produce an average, which is the participant's overall score 560 for that calculation round. In this case, the participant's overall score is −196.5, the strongly negative value of which reflects generally unsatisfactory performance.

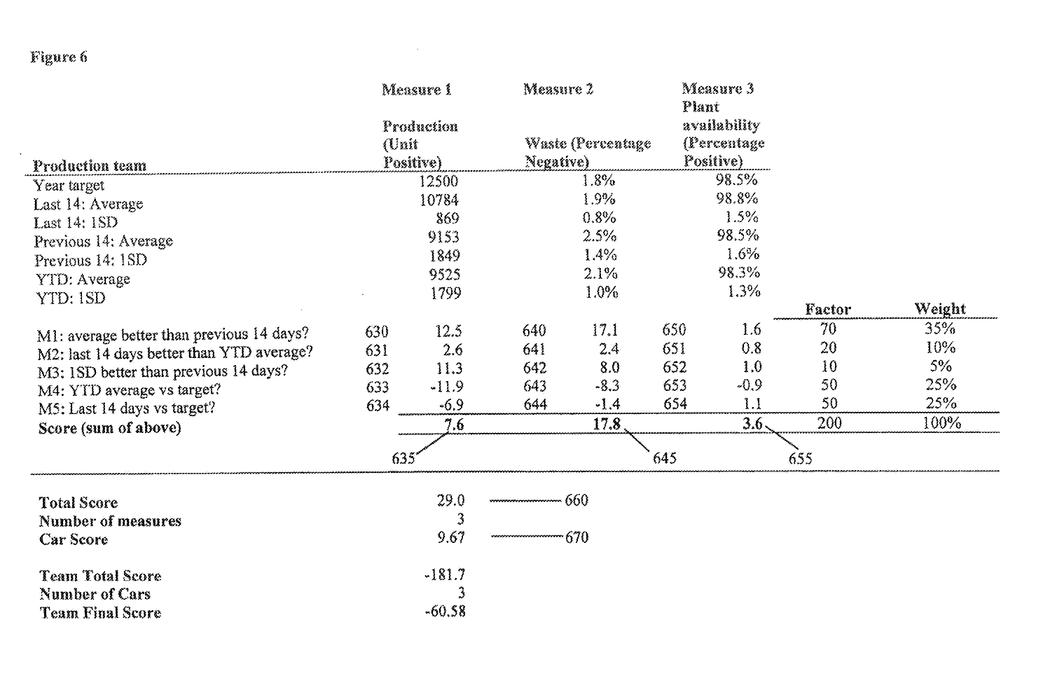

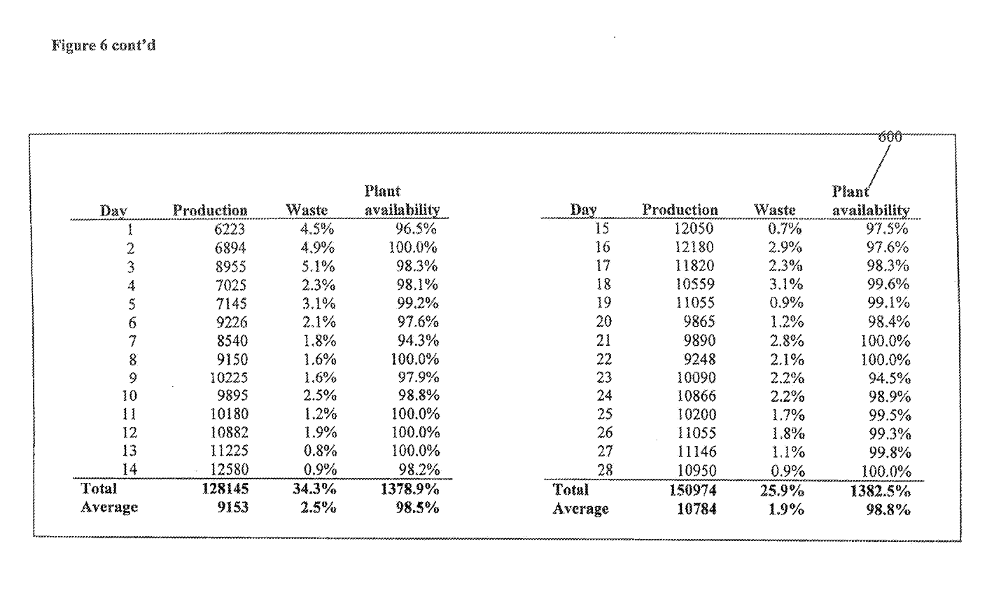

FIG. 6 is a table containing an exemplary set of data and calculation results stored by one embodiment of the present invention for a participant using three different measures of performance. In this example the participant is the production unit at a mine, and the selected performance measures are production (expressed in tonnes per day), plant availability (expressed as a percentage of scheduled operating time) and waste (expressed as a percentage of product recovered). In this case, production is a unit positive measure, availability is a percentage positive measure (ie. a higher percentage is better), and waste is a percentage negative measure (ie. a lower percentage is better).

Calculations 630 through to 634 are for a unit positive measure (production), and therefore proceed in the same manner as described for calculations 430 through to 434 in relation to FIG. 4 above. The resulting overall score for this measure is 7.6.

Calculations 640 through to 644 are in respect of the waste data, which is a percentage negative measure (ie. it is expressed as a percentage, and the lower the value the better).

When comparing value X to value Y for percentage negative measures, the general formula used is the same as that for percentage positive measures, albeit multiplied by minus one:

$$Δ = - [ ( \frac{1.1 - X}{ 1.1 - Y} \times Z ) - Z ]$$

where Z is the relevant weighted factor and A is the weighted % difference between X and Y. Values other than 1.1 may be used in other embodiments, provided that the chosen value is used consistently across all participants—the key element is the ratio between values X and Y and the avoidance of division by zero.

In the first calculation 640 for the percentage negative measure (waste), the short-term performance trend is determined using the above formula, where X is the average for the most recent calculation period (in this case, the past 14 days), and Y is the average for the preceding calculation period. In this case, the average for the most recent 14 days' performance data is 1.9%, and the average for the preceding 14 days' performance data was 2.5%. The result of the calculation is 17.1, with the positive value representing the fact that the average performance for this measure has improved.

In the second calculation 641 for the percentage negative measure (waste), the longer term performance trend is determined using the above formula, where X is the average for the most recent calculation period and Y is the average for the year to date. In this case, the average for the most recent 14 days' performance data is 1.9%, and the average for the year to date is 2.1%. The result of the calculation is 2.4, with the positive value representing the fact that the average performance for this measure has improved.

In the third calculation 642 for the percentage negative measure (waste), the short-term trend in variability of the performance results is determined by dividing the standard deviation of the performance figures for the most recent calculation period by the standard deviation of the performance figures for the preceding calculation period, multiplying the result by the relevant weighted factor, then subtracting the weighted factor from that result. In this case, the standard deviation for the most recent 14 days' performance data is 0.8%, and the standard deviation for the preceding period's data was 1.4%. The result of the calculation is 8.0, with the positive value representing the fact that the variability in results has decreased, implying greater consistency of performance.

In the fourth and fifth calculations, 643 and 644 respectively, the participant's performance against predetermined targets is assessed for each measure.

In calculation 643 for the percentage negative measure (waste), the above formula is used, where X is the average for the year to date and Y is the target value for that year. In this case, the average for the year to date is 2.1%, and the target value for the year is 1.8%. The result of the calculation is −8.3, with the negative value reflecting the fact that the current average is above the target value.

In calculation 644 for the for the percentage negative measure (waste), the above formula is used, where X is the average for the most recent calculation period and Y is the target value for that year. In this case, the average for the most recent calculation period is 1.9%, and the target value for the year is 1.8%. The result of the calculation is −1.4, with the negative value reflecting the fact that the current average remains slightly above the target value.

Calculations 650 through to 654 are for a percentage positive measure (plant availability), and therefore proceed in the same manner as described for calculations 540 through to 544 in relation to FIG. 5 above. The resulting overall score for this measure is 3.6.

The scores for each of the participant's measures, 635, 645 and 655 are then added together to produce the participant's aggregate score 660 for that calculation round. This is then divided by the number of measures used to produce that aggregate score (in this case, three) to produce an average, which is the participant's overall score 670 for that calculation round. In this case, the participant's overall score is 9.67.

In one embodiment of the invention, the scores returned for each participant may be used to generate a graphical representation of the relative position of the participants. For example, each participant may be represented as a car on a race track, with their scores being used to determine how far along the track they have advanced.

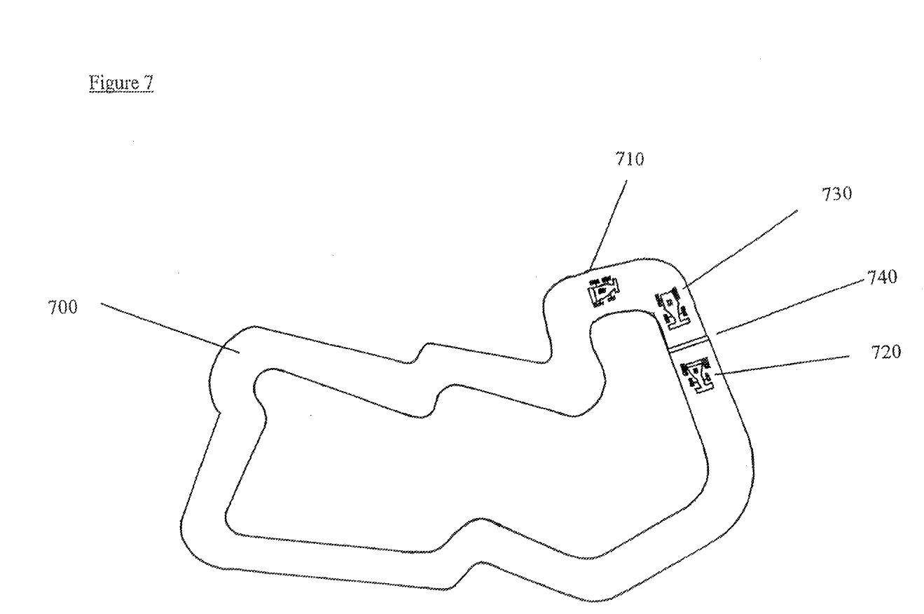

FIG. 7 illustrates one embodiment of a method for displaying the results from the calculation examples illustrated in FIGS. 4 to 6. In this example, car 710 represents the participant whose performance figures and score were described in FIG. 4, car 720 represents the participant from FIG. 5, and car 710 represents the participant from FIG. 6 relative to a finish line 740. The scores for cars 710, 720 and 730 were 5.0, −196.5 and 9.7 respectively, and their relative positions on the track 700 reflect these scores, ie. car 730 is placed first, car 710 is placed second, and car 720 is placed third by a considerable margin. More specifically, the spread between the highest value (9.7) and the lowest value (−196.5) is 206.2. The highest and lowest values define the front and back of the field, and the other participants are placed on the track 700 according to their relative position within these bounds. In this case, car 710 is 201.5 ‘points’ ahead of the back-marker, placing it 97.6% of the way around the track 700, given that the length of the track is effectively defined by the score of the winner.

In addition to there being a winner of the overall competition, the competition itself can be broken down into a number of discrete events towards which participants can aim at regular intervals. For embodiments of the present invention in which calculations are performed at discrete intervals, the results from each round of calculations may constitute one round of the competition. For example, the results of each round of calculations may constitute the results of one ‘race’ within a broader competition. Participants may be awarded points based on their relative positions in each race, with those points being collated to determine the winner of the overall competition.

The competition may be ongoing, or for a fixed period of time. In one embodiment, the calculation dates may correspond to actual events, such as car races, and the duration of the competition may correspond to the duration of the relevant sporting season or championship.

The invention has been explained above with reference to specific embodiments. Other embodiments will be apparent to those skilled in the art in light of this disclosure. The invention may readily be implemented using configurations other than those described in the preferred embodiments above. Additionally, the invention may effectively be used in conjunction with systems other than the one described above. Therefore, these and other variations upon the described embodiments are intended to be covered by the invention, which is limited only by the appended claims.

The word ‘comprising’ and forms of the word ‘comprising’ as used in this description and in the claims does not limit the invention claimed to exclude any variants or additions.

1. A method for improving performance in a business organisation by facilitating competition between two or more different participants within the business, the method comprising;
(a) one or more servers, and
(b) one or more remote terminals accessible by the participants, wherein the method includes the steps of;
(1) choosing a measure of participant performance,
(2) inputting the measure of participant performance to a remote terminal,
(3) calculating a score based on the measure of performance, the calculation being performed at the server, or performed at the remote terminal for communication to the server;
(4) collating and ranking the scores, and
(5) displaying the relative scores of the participants.

2. A method according to claim 1 wherein steps (2) to (5) are repeated until a terminating event occurs.

3. A method according to claim 1 wherein the measure of participant performance is based on a value chosen from the group comprising sales values, budget values, production values, wastage values or occupational health and safety values.

4. A method according to claim 1 wherein the score is calculated based on the measure of participant performance against a predetermined target.

5. A method according to claim 1 wherein the score is calculated based on at least one change in performance over a time period.

6. A method according to claim 1 wherein the score is calculated by determining a first average score for a first calculation period and comparing the first average score with a second average score for a second calculation period.

7. A method according to claim 1 wherein the score is calculated by determining a first average score for a first calculation period and comparing the first average score with a second average score for a calculation period comprising the year to date.

8. A method according to claim 1 wherein the score is calculated by determining first variance in scores for a first calculation period and comparing the first variance in scores with a second variance in scores for a second calculation period.

9. A method according to claim 1 wherein the relative scores are displayed in numerical or graphical form

10. A system for improving performance in a business organisation by facilitating competition between two or more different participants within the business, the system comprising;
(a) one or more servers, and
(b) one or more remote terminals accessible by the participants, wherein the system includes;
(1) communicating a measure of participant performance to a remote terminal,
(2a) communicating the measure of participant performance to the server for calculation of a score, or
(2b) communication to the server a score calculated at the remote terminal,
(3) communication of collated and ranked scores to the remote terminal, and
(4) display of the collated and ranked scores to show their relative values.

11. A system according to claim 10 wherein steps (2a) to (4) are repeated until a terminating event occurs.

12. A system according to claim 10 wherein the measure of participant performance is based on a value chosen from the group comprising sales values, budget values, production values, wastage values or occupational health and safety values.

13. A system according to claim 10 wherein the score is calculated based on the measure of participant performance against a predetermined target.

14. A system according to claim 10 wherein the score is calculated based on at least one change in performance over a time period.

15. A system according to claim 10 wherein the score is calculated by determining a first average score for a first calculation period and comparing the first average score with a second average score for a second calculation period.

16. A system according to claim 10 wherein the score is calculated by determining a first average score for a first calculation period and comparing the first average score with a second average score for a calculation period comprising the year to date.

17. A system according to claim 10 wherein the score is calculated by determining first variance in scores for a first calculation period and comparing the first variance in scores with a second variance in scores for a second calculation period.

18. A system according to claim 10 wherein the relative scores are displayed in numerical or graphical form.

19. A server when used for carrying out the method of claim 1 wherein the server is configured to:
(i) receive and store the measure of participant performance from a remote terminal,
(ii) calculate a score based on the measure of participant performance or receive and store a score calculated at a remote terminal,
(iii) collate and rank the calculated score, and
(iv) display the relative scores of the participants.

20. A server according to claim 19 wherein steps (ii) to (iv) are repeated until a terminating event occurs.

21. A server according to claim 19 wherein the measure of participant performance is based on a value chosen from the group comprising sales values, budget values, production values, wastage values or occupational health and safety values.

22. A server according to claim 19 wherein the score is calculated based on the measure of participant performance against a predetermined target.

23. A server according to claim 19 wherein the score is calculated based on at least one change in performance over a time period.

24. A server according to claim 19 wherein the score is calculated by determining a first average score for a first calculation period and comparing the first average score with a second average score for a second calculation period.

25. A server according to claim 19 wherein the score is calculated by determining a first average score for a first calculation period and comparing the first average score with a second average score for a calculation period comprising the year to date.

26. A server according to claim 19 wherein the score is calculated by determining first variance in scores for a first calculation period and comparing the first variance in scores with a second variance in scores for a second calculation period.

27. A server according to claim 19 wherein the relative scores are displayed in numerical or graphical form.

28. Code for operation of the server and remote terminal of claim 1 including;
(1) programming code for receiving input of a measure of participant performance to a remote terminal,
(2a) programming code for calculating a score based on the measure of performance at the server, or
(2b) programming code for calculating a score based on the measure of performance performed and programming code for communicating the score to the server,
(3) programming code for collating and ranking the scores, and
(4) programming code for displaying the relative scores of the participants.

29. Code according to claim 28 which further includes programming code for calculating a first average score for a first calculation period and comparing the first average score with a second average score for a second calculation period.

30. Code according to claim 28 which further includes programming code for calculating a first average score for a first calculation period and comparing the first average score with a second average score for a calculation period comprising the year to date.

31. Code according to claim 28 which further includes programming code for calculating a first variance in scores for a first calculation period and comparing the first variance in scores with a second variance in scores for a second calculation period.
